(19) United States
(12) Patent Application Publication
(10) Pub. No.: US 2026/0260630 A1
(43) Pub. Date: Sep. 3, 2026

(54) DISPLAY SYSTEM

(71) Applicant: AUDI AG, Ingolstadt (DE)

(72) Inventors: Werner THOMAS, Münchsmünster (DE); Reiner LENDLE, Hassmersheim (DE)

(21) Appl. No.: 19/159,582

(22) PCT Filed: Feb. 19, 2024
(86) PCT No.: PCT/EP2024/054172

§ 371 Date: Aug. 25, 2025

(30) Foreign Application Priority Data
Feb. 26, 2023 (DE) 10 2023 104 659.4

(51) Int. Cl. G09G 3/34

(52) U.S. Cl. CPC G09G 3/344; G09G 3/3426; G09G 2320/062; G09G 2320/0666; G09G 2380/10

(57) ABSTRACT

A display system for a vehicle is disclosed, and may include a display field, a controllable optical screen, and a control device. The device optical screen may be arranged on and/or in front of the display field. The display field may be configured to represent a display content. The control device may be configured to control the screen by way of signals. The screen may be configured to selectively represent a design which at least partially covers the display field based at least in part on the signals provided by the control device.

### BACKGROUND

### Technical Field

The present disclosure relates to a display system for a vehicle and a method for representation of a design on and/or in front of a display content.

### Description of the Related Art

The publication EP 3 907 109 A1 describes a logo arrangement for a motor vehicle.

A luminaire arrangement is known from the publication DE 20 2020 107 229 U1.

The publication EP 3 869 090 A1 describes an assembly for the illuminated representation of an emblem.

A license plate device for a vehicle is described in the publication EP 2 741 940 B1.

In this context, one task was to suitably represent a vehicle logo.

### BRIEF SUMMARY

The display system according to the present disclosure is configured for a vehicle, for example, a motor vehicle. The display system comprises one display field, one, usually digitally, controllable and/or switchable optical screen, and one control device, wherein the optical screen is arranged on, in front of and/or above the display field and covers the latter at least partially or completely, usually physically. The optical screen may be optically variably adjustable. The display field is configured to represent a display content, wherein the control device is configured to automatically control the screen by way usually digital, signals, for example, screen signals and/or design signals. The switchable optical screen, taking into account the signals provided by the control device for control, is configured to selectively represent a design, for example, at least one symbol and/or one pattern, which is to say to represent the design or to prevent or avoid representing the design. The specifically represented design covers and/or superimposes the display field, and the display content of the display field in some embodiments, at least partially, usually optically, irrespective of whether the display content is actively represented by the display field or not. For this purpose, the control device is connected to the screen and the display field via lines for transporting the signals. In some embodiments, the design can be illuminated from behind or from below with the display content of the display field arranged behind or below it.

The optical screen or a corresponding shutter that is controllable and/or switchable by the, usually digital, screen signals is, for example, configured as switchable glass, configured as a, usually unlit, thin-film transistor display (“TFT”), which is to say, as a thin-film transistor with liquid crystals without backlight or alternatively background lighting, and/or has electrical ink. Usually, a TFT array or an array of thin-film transistors with a liquid crystal matrix (“TFT+liquid crystal”) can also be used as screen or optical shutter. In some embodiments, the screen signals of the control device may be electrical and are provided by at least one electrical parameter. In this case, an electrical voltage is applied and/or an electrical current is conducted as the at least one electrical parameter for the screen signals at the screen, wherein the design is selectively generated by and/or with the screen depending on the at least one electrical parameter. Alternatively or additionally, the display field has light elements, usually semiconductor-based, which are configured as light-emitting diodes (LEDs), organic light-emitting diodes (OLEDs) or mini light-emitting diodes, for example, micro-light-emitting diodes (μLEDs). The display field is highly segmented and has a number of light elements. The display field can have a small number or a large number of light elements, for example, pixels. In some embodiments, the display field may be configured as a liquid crystal display, for example, as a usually backlit LCD or alternatively liquid crystal display with backlight or background lighting, or as a simple, low-cost light source. The display content provided by a display field configured as a light source is at least one-colored. The screen is temporarily switched to be transparent or permanently transparent and with the design represents, for example, a logo. The light elements can be arranged as a chain or in at least one row. In some embodiments, the light elements may be configured as light guides. The display content can be static or animated. In some embodiments, the display field may be used to display content to represent, for example, a warning symbol or a company logo.

The screen is configured as the front and/or upper visible component and the display field as the rear and/or lower visible component of the display system. In some embodiments, the screen may comprise at least one zone or at least one area, namely a design area, for example, a symbol area, for representing, and in which the design is selectively represented. This at least one area for the design is selectively switched on at least partially, or entirely, to be translucent, transparent, or opaque. The at least one area for the design may be colored, including one-colored or multicolored, or alternatively metallic, black or white. Accordingly, the design is represented at least partially or completely opaque, wherein one color of the design can either be static or can be changed dynamically, wherein the design can also optionally be represented, completely, in an animated manner. In some embodiments, the at least one area may be set to be transparent for the design and may furthermore set a color of the display content, which can, for example, be metallic, wherein the correspondingly colored display content is visible through the at least one transparently switched area of the screen and the design appears correspondingly colored.

Furthermore, the screen can be subdivided into at least two different areas or alternatively zones, wherein at least one area is at least partially to be switched or switched translucent and at least one further area is at least partially opaque, usually by way of the screen signals of the control device. Each of these areas has a surface, wherein the screen can be subdivided, including dynamically and flexibly, into respectively a predetermined number of different areas, which can, moreover, be deformed, including with respect to one dimension of its surfaces. The design is in at least one, usually centrally and symmetrically arranged, area, namely the design area, represented with or by the screen. The screen is or will be enclosed or surrounded by at least one background area as a further area of the screen, wherein the screen is subdivided into the at least one design area and the at least one background area for the design. Depending on the shape of the design, the at least one design area may also surround or enclose at least one further background area, wherein a contour of the design can be visually emphasized. On the one hand, the at least one design area may be switched to be translucent for the design and the at least one background area switched to be opaque. On the other hand, the at least one design area for the design may be switched to be opaque and the at least one background area may be switched to be translucent. In this case, the display field and thereby represented display content are visible through at least one translucent area of the screen and invisible through at least one opaque area, since it is or will be covered by this area in some areas, usually optically.

On the one hand, the design may be positively represented on the at least one design area switched to be opaque within the at least one background area switched to be translucent and is visually emphasized by the display content of the display field represented behind it, which is illuminated by the at least one background area. On the other hand, the design may be negatively represented on the at least one design area switched to be translucent within the at least one background area switched to be opaque and is visually emphasized by the display content of the display field represented behind it, which is illuminated by the at least one design area. The screen can be dynamically or statically divided or subdivided or switched into the at least two areas, which is to say, the at least one design area and background area, or alternatively corresponding zones.

The screen arranged on or in front of the display field can comprise a smaller area than the display field or the same area as the display field and, in the latter case, be congruent with the display field. The screen or its area is at most as large as or larger than the display field or its area, wherein the screen located on or in front of the display field may be implemented or, at least optically visible, in the display field. The screen is also connected to the display field mechanically, either directly or indirectly via a connecting element, and is usually attached to it directly or indirectly. If the screen is larger than the display field, the screen covers the display field behind and/or below it, wherein the entire display system can be designed seamlessly.

As a rule, the design is represented by the at least one design area of the screen. The usually colored display content of the display field is visible through the at least one translucent area, which is to say, depending on the switching of the screen by the control device, either through the at least one design area or the at least one background area of the screen and, on the other hand, is covered, usually optically, by the at least one area switched to be opaque.

If the design in the at least one design area within the at least one background area switched to be translucent is represented opaquely, usually in at least one color, for example, metallic, at least one color of the design can either be static or can be changed dynamically, wherein the design can also be represented, optionally completely, in an animated manner. Alternatively, the design is represented to be translucent in the at least one design area, wherein the at least one background area of the screen is switched to be opaque. The entire screen can, moreover, be switched to be translucent, wherein an area of the at least one design area is reduced to zero and an area of the at least one translucent background area is extended to the entire screen, wherein the design is selectively not represented. In some embodiments, the design area may be set accordingly and may define a shape of the design. However, in some embodiments the screen may have the shape of the design, wherein the screen in its configuration comprises the entire design area and is set to be either colored or translucent.

In some embodiments, the screen is configured to be static or unchangeable with a static or fixed design and thus always has the same unchangeable design. In this case, the screen together with the design is permanently partially transparent, wherein only the background area is switched between transparent and non-transparent or opaque. The static design can be used, for example, to permanently represent a logo of a manufacturer of the vehicle. The design on the screen can likewise also be switched between transparent and non-transparent or alternatively opaque, wherein the background area is always transparent in this case. The logo of a manufacturer can be represented, for example, in a non-transparent manner, more or less colored, for example, white, or disappear when in active state. The design can be illuminated and/or represented by the display content of the display field when the display field is in an active state, wherein an entire area of the display field is used to represent the display content.

In some embodiments, the screen and the design to be represented thereby is designed to be dynamic and variable, wherein an active state and a passive state is or can be set or adjusted for the screen. The screen is electrically connected to the control device in the active state and is supplied electrically with current and/or a voltage by the control device and controlled with the screen signals. In the passive state, on the other hand, the screen is generally electrically disconnected from the control device and is neither electrically supplied nor controlled thereby. The screen is configured to adjust the design to be selectively represented by thereby depending on the signals from the control device, usually the screen signals, and optionally also to change the design when the screen is in the active state, wherein a shape, color and/or size of the design can be or is changed. With the, or by the at least one opaque design area, the design can be, or be represented as, one-colored or monochrome or multicolored, wherein the colored design can also be metallic and thus light-reflecting or reflective. If the at least one design area is switched to be translucent and the at least one background area is switched to be opaque, the display content, which can also be metallic and therefore light-reflecting or reflective, is visible through the at least one design area and also appears to be metallic. In some embodiments, different designs may be alternatively represented with the screen.

The screen is moreover configured to optically fix and/or retain, for example, to preserve, a representation for the design that is set by the control device and specified via the screen signals. The screen is, moreover, configured to maintain and/or retain this representation set for the design, even in the passive state, if no screen signals are provided to it by the control device without being supplied electrically with a current and/or a voltage by the control device.

The control device is, moreover, configured to control the display field or display using additional signals, for example, digital display signals, independently of the screen signals, and to cause a representation of the display content. The control device can control or actuate the screen and the display field in a disconnected manner or separately and also set or vary the display content dynamically, wherein an animated display content can also be represented. An active state and a passive state can also be set for the display field, wherein in the active state the display field is electrically connected to the control device and switched on or off and is controlled with the display signals for the display content, which is either static or dynamically changed. In the passive state, on the other hand, the display field is powered off and electrically disconnected from the control device. In some embodiments, a display content set in the active state may also be fixed and/or retained in the passive state on the display field. The display content can be colored in both states, for example, metallic, black or white.

A warm design can moreover be set, provided and/or made available for the visible components of the display system, which is to say, the screen and the display field, when the display field is in the active state and is illuminated or will be illuminated by, or from or with the display content, and a cold design when the display field is in the passive state and is non-illuminated. Usually, the active state for the screen is then set when the display field is in the active state, optionally only then, wherein the display field can be moved to the passive state as soon as the design, for example, the at least one symbol, is fixed. In the warm design, the display field is in the active state and the screen is either in the active or passive state. In the cold design, the display field is in the passive state and the screen is usually in the passive state, wherein the screen, in the cold design, can also be switched on and moved to the active state if the design optionally needs to be changed.

In both the warm and cold designs, the screen can also be switched to be completely translucent or opaque in the active state and switched to be completely translucent or opaque in the passive state. The display field is completely visible and is not optically covered when the screen is or will be switched to be translucent. This is possible if the visible components, which is to say, the screen and the display field, are located on an outer or inner wall, depending on the design.

The display content of the display field, which, in particular, is arranged on the outer wall, is configured to provide and/or represent information to other road users in the vicinity of the vehicle, for example, relating to a trajectory to be traveled in the future and/or functions performed or to be performed by the vehicle. The display field is arranged at and/or on the outer wall on the nose at the front or on the tail at the rear of the vehicle and can extend over an entire transverse axis of the vehicle, wherein the display content can be represented over the entire width of the vehicle. The display field can be used to represent, for example, animated light signals for exterior lighting of the vehicle as possible display content. With such light signals, it is possible to represent or display to other road users a change in the direction of travel, in a manner analogous to a turn signal, braking, analogous to a brake light, and/or reversing, analogous to a reversing light, as possible functions of the vehicle. In some embodiments, a low beam, a high beam, a tail light and/or a rear fog light may be represented and/or simulated with the display content of the display field as exterior lighting. The display content can be dynamically adapted and/or changed, wherein at least one exterior light and/or at least one function can be a representation in combination with one another. In some embodiments, optical and/or light-supported communication and/or interaction with other road users (e.g., c2x, car-to-x), for example, with other vehicles, usually vehicle-to-vehicle communication (e.g., c2c, car-to-car), may be provided with the display field as display content, for example, by representation of designs. The display field is usually used to represent display content to inform and/or warn other road users, wherein road safety functions are provided. This also comprises, for example, a representation of a proximity detection that protects against rear-end collisions.

The display field and the screen are arranged onto and/or on an outer wall, usually a body, of the vehicle or onto and/or on an inner wall in an interior of the vehicle. Alternatively or additionally, the screen and the display field are arranged symmetrically to a central longitudinal axis as an axis of symmetry, parallel to a direction of travel of the vehicle, wherein the display field can extend along a complete width of the vehicle, more or less at the nose or tail. Due to such a central placement, only one single display field with which information is displayed communicatively (e.g., car-to-x) is required, since the axis of symmetry runs centrally through the display field or alternatively through the display and a vehicle center.

The method according to the present disclosure is configured to represent, usually digitally and/or selectively, a design, for example, at least one symbol and/or one pattern, on and/or in front of a display content with a display system, for example, with an embodiment of the display system presented, for a vehicle, wherein the display system has a display field, a controllable and/or switchable optical screen, and a control device. The optical screen is arranged on, in front of and/or above the display field and can optionally be completely switched and changed digitally. The display content is represented by the display field. The screen is automatically controlled by signals, which are usually digital, for example, screen signals, of the control device, wherein the design is selectively represented by the switchable optical screen, taking into account the signals provided for controlling. The display field, and usually also the represented display content of the display field, is at least partially optically covered by the design represented. However, in some embodiments, the design may be deleted and/or not represented with the screen signals by the control device, wherein the design is not represented in a specific and controlled manner.

In some embodiments, the design and the display content behind the design are synchronously represented in combination. As a rule, the display content is adapted and changed by the display signals provided by the control device, usually digitally, automatically and/or dynamically. In contrast, the design is set at least once, usually only once, by the screen signals or alternatively design signals provided by the control device in the active state and is still statically fixed or alternatively retained, for example, preserved, wherein the screen may be electrically disconnected from the control device after setting and usually fixing the design and moved into the passive The usually static design continues to be represented on and/or in front of the display field and thus on and/or in front of the display content even in the passive state, wherein at least one color that is or has been selected and set for the design may also be fixed and retained in the passive state. If the at least one area of the screen for the design is transparent in the passive state of the screen, the display field can also be set or be in the passive state, wherein a color, for example, metallic, black or white, of the display content is fixed and visible through the at least one transparent area.

The, for example, digitally set or alternatively digital design can also be designed or designated as a logo, for example, a brand logo, and thus as a corresponding symbol that refers to a manufacturer of the vehicle. However, in some embodiments, the design or its appearance can be selected and/or modeled by a user of the vehicle, wherein the user specifies the design provided by them individually, for example, by way of an input device, which in turn provides the control device with a specification for the screen signals. The design can comprise at least one symbol and/or at least one character, for example, graphic characters, which is to say, at least one letter of the alphabet and/or one number.

The design, for example, the digital brand logo, which is represented by the screen, is visible both in an active state of the vehicle when it is usually driving, but also in the passive state of the vehicle when it is parked, since in the latter case the design has previously been fixed in the active state of the screen and is still retained and displayed or alternatively represented independently of the control device. The method and the display system are also provided for a vehicle that is designed to drive at least temporarily, autonomously or alternatively automatically and/or under machine control. The vehicle equipped with the display system can communicate with other road users, for example, pedestrians or cyclists, with the design and the display content by way of the display system. Possible use cases include early communication, for example, to draw attention to certain hazardous situations or similar. Functions can also be assumed and information provided if there is no direct eye contact between a vehicle driver and the other road users, for example, to resolve a deadlock situation or similar. This is also possible when the vehicle is driving semi-automatically, which allows the driver to take their eyes off the road.

The vehicle equipped with the display system, for example, an “own vehicle”, can also communicate and/or interact with a further road user, which is to say, another vehicle, for example, a “third-party vehicle”, by way of the represented, for example, animated, display content if this third-party vehicle has a sensor, for example, a camera, for optical recognition of the display content of the display system of the own vehicle. Furthermore, the own vehicle can also have a sensor, for example, a camera, for optically recognizing a display content that is represented by a display field of the third-party vehicle, wherein the display field can also be configured as a component of the display system of the presented embodiment. This sensor of the own vehicle can exchange information with the control device of the display system and optionally also be configured as a component of the display system. Both vehicles, which is to say, the own vehicle and the third-party vehicle, can communicate and/or interact with each other, usually automatically, by way of reciprocal sensory detection of optical display content and thus, among other things, warn each other of potentially dangerous traffic situations, wherein optical vehicle-to-vehicle communication is possible, and data and/or information can be transmitted optically between the vehicles. Usually, using the represented display content, the own vehicle can also communicate optically with people, which is to say, pedestrians but also occupants of third-party vehicles, and provide them with information.

At least three different operating modes can be set for the two visible components of the display system. In a first and a second operating mode, the design, for example, the logo, is represented by the screen in both the active and passive state. In the first operating mode, the display field is in the active state, wherein the design is illuminated by the represented display content of the display field shown behind or below it. In the second operating mode, the display field is in the passive state, wherein the design is not illuminated by the represented display content of the display field shown behind or below it, which is to say, the design remains unlit but is still visible. In a third operating mode, the screen will be and/or is completely translucent or transparent in both the active and passive state, wherein the display content of the display field is completely visible through the screen, since the design is invisible, and the display field can be used completely or fully for representation of the display content. By combining the screen and the display field, the operating modes and/or functions can be shown or represented, wherein the design, for example, the logo of the manufacturer, can be produced to a high quality standard in a cold state among others.

With the display field in the active state, the display content can be used to display different functions, for example, lighting functions and/or safety functions and/or to set a personalized design, for example, lighting design, for the user. In some embodiments, the design, for example, symbol, may be personally set by the user. Specifications for a particular operating mode and/or a design can be entered into the input device by the user and/or loaded from a database. The display system can also be used to set a color for the vehicle, wherein it is possible to switch between different colors.

It is understood that the features mentioned above and the features to be elucidated below can be used not only in the respective combination indicated, but also in other combinations or on their own, without going beyond the scope of the present disclosure.

### BRIEF DESCRIPTION OF THE SEVERAL VIEWS OF THE DRAWINGS

FIG. 1a, FIG. 1b, and FIG. 1c show a schematic representation of one embodiment of the display system according to the present disclosure when carrying out an embodiment of the method according to the present disclosure.

### DETAILED DESCRIPTION

The figures are described in a coherent and comprehensive manner. The same reference signs are assigned to the same components.

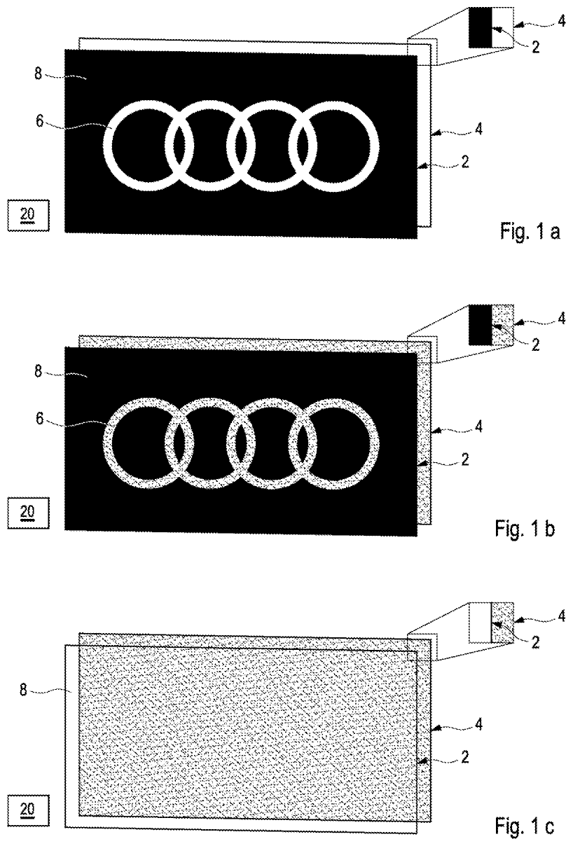

The different operating modes of the embodiment of the display system according to the present disclosure, represented in FIG. 1a through FIG. 1c, for a vehicle, in this case for a motor vehicle, comprises one screen 2 and one display field 4 as visible components, wherein the screen 2 is arranged on or in front of the display field 4, is directly or indirectly connected thereto and, for example, is directly or indirectly fastened there to. The screen 2 and the display field 4 are respectively represented in each of FIG. 1a, FIG. 1b, and FIG. 1c, from a main perspective, wherein, in each of FIG. 1a through FIG. 1c, a detail of the screen 2 and of the display field 4 is also represented in sectional view. A control device 20, as a further component of the display system, is at least temporarily electrically connected to at least one of the two visible components and controlled, or alternatively, electrically disconnected and/or not controlled, wherein an active state is set for the screen 2 or the display field 4 when electrically connected to the control device 20 and controlled, an a passive state is set for the screen 2 or the display field 4 when electrically disconnected from the control device 20 and/or not controlled.

In the embodiment of the method according to the present disclosure, the optically switchable and/or adjustable screen 2 and the display field 4 or a display are controlled or actuated, by signals from the control device 20, namely by screen signals for the screen 2 and display signals for the display field 4, and are thereby also switched when electrically connected to the control device 20 for exchanging the signals.

The screen 2 controlled by the screen signals is thereby subdivided or alternatively segmented for representing a design, into one design area 6 for this design and here several background areas 8 as background for the design. The switchable screen 2 is thereby designed, for example, as a switchable glass, as a thin-film transistor display or has electrical ink. The display field 4 for representing a display content comprises light elements, for example, light-emitting diodes (LEDs), in the form of organic light-emitting diodes (OLEDs), or is designed as a liquid crystal thin-film transistor display (LCD TFT), which is usually backlit. Both visible components are arranged here on a wall of the vehicle, which is to say, on an outer wall or on an inner wall in an interior space for occupants of the vehicle. The control device 20 can also control further functions of other systems of the vehicle, independently of the method presented.

The design shown here comprises four contiguous rings arranged next to each other, which exemplarily represent a company logo of AUDI™ AG, wherein two directly adjacent rings intersect and are connected to each other. The rings or alternatively their contour is represented here by the design area 6 within an outer background area 8 which surrounds the design area 6, wherein the design area 6 surrounds or alternatively encloses further background areas 8, which are all delimited by the contour of the rings.

In the embodiment of the method presented here, the screen 2 and the display field 4 are initially controlled in the active state by the signals of the control device 20, wherein the design area 6 is switched or set to be translucent or alternatively transparent. In addition, at least one color, which is to say, only one color or a plurality of colors, is represented as the display content of the display field 4 in the active state. The at least one color of the display field is or remains visible even in the passive or inactive state of the display field. If the display field comprises organic light-emitting diodes (OLEDs), the display content may appear to be metallic, for example, silver or chrome-colored, wherein a color can be predetermined by hardware by way of the organic light-emitting diodes.

This results in a first operating mode shown in FIG. 1a, with which a warm design is realized if or as long as at least one of the two visible components, here at least the display field 4 and optionally also the screen 2, is in the active state. If the screen 2 is in the active state, a subdivision of the screen 2 may be fixed into the design area 6 and the background areas 8 and to retain the screen 2 in the passive state after electrical disconnection from the control device 20. If the display field 4 is in the active state, the display content of the display field 4 may be fixed, in this case the set metallic color, and also retain the display content after electrical disconnection from the control device 20. Alternatively, the color of the display content can be predefined by the hardware in both the active and passive states. After electrical disconnection of the screen 2 and of the display field 4 from the control device 20, a cold design as the second operating mode results in the passive state of the screen 2 and the display field 4, which is also retained when the vehicle is parked and powered off. In both operating modes, the silver rings, for example, are represented against a black background and appear like a conventional logo that is designed as an emblem on a vehicle body.

A further possible third operating mode is schematically indicated in FIG. 1b. In so doing, the subdivision of the screen 2 into the design area 6 and the background areas, from the operating modes in FIG. 1a, is retained, which is possible when the screen 2 is in the active or passive state. Furthermore, the display content of the display field 4, in this case its color, is changed from metallic to a bright color of the color spectrum, for example, red. The translucent design area 6 of the screen 2 is shone through and/or illuminated with the bright color by the display content as long as the display field 4 is in the active state, wherein a warm design is also implemented.

In a fourth operating mode, which is shown in FIG. 1c, the entire screen 2 is already switched or is switched to translucent, which here means that a surface of the design area 6 is reduced to zero in the active state and the design area 6 is deleted, correspondingly, only a background area 8 switched to be translucent or alternatively its surface is now extended to the entire screen 2, which is also retained when the screen 2 is switched to the passive state. In addition, the display field 4 continues to represent the luminous color from the optical color spectrum as display content as long as the display field 4 is in the active state, wherein a warm design is also implemented. However, in some embodiments, the display field 4 may represent a multi-colored, dynamic display content instead of a static, one-colored display content, which is completely visible through the completely translucent screen 2, as it is not covered by the design.

In some embodiments, in the active and/or passive state, the screen 2 may be switched to be translucent in at least one first area and to be opaque in at least one second area, as shown in FIG. 1a and FIG. 1b, by subdividing the screen 2 into at least two areas, which is to say, into at least one design area 6 and at least one background area 8, or that the screen 2 is switched to be translucent in all areas, as shown in FIG. 1c, or that the screen 2 is switched to be opaque in all areas and in this case conceals the display content. Each area can therefore be switched and/or set to be either translucent or opaque. It should be taken into account that, from a hardware perspective, the degree of transmission of a respective area can, as a rule, never be set to be 100% translucent or alternatively transparent or to be 0% opaque, so that the respective area can only be set, in an idealized manner, to be completely translucent or opaque in an idealized manner.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A display system for a vehicle, comprising:
a display field;
a controllable optical screen; and
a control device,
wherein the optical screen is arranged on and/or in front of the display field,
wherein the display field is configured to represent a display content,
wherein the control device is configured to control the screen by way of signals, and
wherein the screen is configured to selectively represent a design which at least partially covers the display field based at least in part on the signals provided by the control device.

2. The display system according to claim 1, wherein the screen is configured as a switchable glass, is configured as a thin-film transistor display, and/or includes electrical ink, and
wherein:
the display field comprises light elements configured as organic light-emitting diodes or as micro-light-emitting diodes, or
the display field is configured as a liquid crystal display or as a light source.

3. The display system according to claim 1, wherein the screen is subdivided into at least two areas,
wherein at least one area is configured to be switched to be at least partially translucent, and
wherein at least one further area is configured to be switched to be at least partially opaque.

4. The display system according to claim 1, wherein the screen is configured to represent the design in color or in a translucent manner.

5. The display system according to claim 1, wherein the screen is static and has a static design, or
wherein the screen is configured to fix and/or retain a representation set by the control device for the design.

6. The display system according to claim 1, wherein the screen is configured to be set in one of an active state and a passive state,
wherein the screen is electrically connected to the control device in the active state and is electrically disconnected from the control device in the passive state,
wherein the screen is configured to set the design to be represented as a function of the signals provided by the control device.

7. The display system according to claim 1, wherein the display field and the screen are arranged on an outer wall of the vehicle and/or symmetrically to a central longitudinal axis of the vehicle.

8. The display system according to claim 1, wherein the control device is configured to control the display field by way of signals and to cause the display content to be represented.

9. The display system according to claim 8, wherein the display content of the display field is configured to represent information to road users in an area surrounding the vehicle.

10. A method for representing a design on and/or in front of a display content with a display system for a vehicle, comprising:
representing display content by a display field of the display system;
controlling an optical screen by way of signals from a control device, the screen arranged on and/or in front of a display field; and
selectively representing the design by the screen based at least in part on the signals provided by the control device,
wherein the display field is at least partially covered by the represented design.
